(19) United States
(12) Patent Application Publication
(10) Pub. No.: US 2016/0352264 A1
(43) Pub. Date: Dec. 1, 2016

(54) APPLICATION DEVICE, MOTOR COMPONENT AND MOTOR DRIVER CIRCUIT

(71) Applicant: Johnson Electric S.A., Murten (CH)

(72) Inventors: Chi Ping SUN, Hong Kong (CN); Shing Hin YEUNG, Hong Kong (CN); Xiu Wen YANG, Shen Zhen (CN); Fei XIN, Shen Zhen (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Li Sheng LIU, Shen Zhen (CN); Yan Yun CUI, Shen Zhen (CN)

(21) Appl. No.: 15/231,190

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN2015/086422, filed on Aug. 7, 2015.

(30) Foreign Application Priority Data
Aug. 8, 2014 (CN) 201410390592.2
Aug. 15, 2014 (CN) 201410404474.2
Jun. 16, 2016 (CN) 201610437236.0

(51) Int. Cl. H02P 6/16; H02P 6/26; H02K 21/14; H02K 11/215; H02K 1/27

(52) U.S. Cl. CPC H02P 6/16; H02K 11/215; H02K 1/2706; H02K 21/14; H02P 6/26

(57) ABSTRACT

An application device, a motor component and a motor driver circuit are provided according to the invention. The motor driver circuit includes: a controllable bi-direction alternating current switch connected in series with a motor across an external alternating current power source; a switch control circuit configured to control the controllable bi-direction alternating current switch to be turned on or turned off in a preset manner; and a delay circuit configured to delay a turn-on for the controllable bi-direction alternating current switch for a preset time to decrease a phase difference between a current flowing through the motor and a counter electromotive force. The motor driver circuit can improve a power efficiency of the motor.

### CROSS REFERENCE TO RELATED APPLICATIONS

This application is a continuation-in-part of co-pending U.S. patent application Ser. No. 14/822,353, filed on Aug. 10, 2015, which claims priority under 35 U.S.C. §119(a) from Patent Application No. 201410390592.2 filed in the People's Republic of China on Aug. 8, 2014, and Patent Application No. 201410404474.2 filed in the People's Republic of China on Aug. 15, 2014; this application claims priority under 35 U.S.C. §119(a) from Patent Application No. 201610437236.0 filed in the People's Republic of China on Jun. 16, 2016, Patent Application No. PCTCN2015086422 as PCT application filed in Receiving Office of CN on Aug. 7, 2015, all of which are expressly incorporated herein by reference in their entireties and for all purposes.

### FIELD

The present disclosure relates to the technical field of motor, and in particular to a motor driver circuit.

### BACKGROUND

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. To ensure the starting of a conventional synchronous motor, a starting point of the motor is set to be low, which results in that the motor cannot operate at a relatively high working point, thus the efficiency is low. In another aspect, the rotor cannot be ensured to rotate in a same direction every time since a stop or stationary position of the permanent magnetic rotor is not fixed. Accordingly, in applications such as a fan and water pump, the impeller driven by the rotor has straight radial vanes, which results in a low operational efficiency of the fan and water pump.

FIG. 1 illustrates a conventional drive circuit for a synchronous motor, which allows a rotor to rotate in a same predetermined direction in every time it starts. In the circuit, a stator winding 1 of the motor is connected in series with a TRIAC between two terminals M and N of an AC power source VM, and an AC power source VM is converted by a conversion circuit DC into a direct current voltage and the direct current is supplied to a position sensor H. A magnetic pole position of a rotor in the motor is detected by the position sensor H, and an output signal Vh of the position sensor H is connected to a switch control circuit PC to control the bidirectional thyristor T.

FIG. 2 illustrates a waveform of the drive circuit. It can be seen from FIG. 2 that, in the drive circuit, no matter the bidirectional thyristor T is switched on or off, the AC power source supplies power for the conversion circuit DC so that the conversion circuit DC constantly outputs and supplies power for the position sensor H (referring to a signal VH in FIG. 2). In a low-power application, in a case that the AC power source is commercial electricity of about 200V, the electric energy consumed by two resistors R2 and R3 in the conversion circuit DC is more than the electric energy consumed by the motor.

The magnetic sensor applies Hall effect, in which, when current I runs through a substance and a magnetic field B is applied in a positive angle with respect to the current I, a potential difference V is generated in a direction perpendicular to the direction of current I and the direction of the magnetic field B. The magnetic sensor is often implemented to detect the magnetic polarity of an electric rotor.

As the circuit design and signal processing technology advances, there is a need to improve the magnetic sensor integrated circuit for the ease of use and accurate detection.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a prior art drive circuit for a synchronous motor, according to an embodiment of the present disclosure;

FIG. 2 illustrates a waveform of the drive circuit shown in FIG. 1;

FIG. 3 illustrates a diagrammatic representation of a synchronous motor, according to an embodiment of the present disclosure;

FIG. 4 illustrates a block diagram of a drive circuit for a synchronous motor, according to an embodiment of the present disclosure;

FIG. 5 illustrates a drive circuit for a synchronous motor, according to an embodiment of the present disclosure;

FIG. 6 illustrates a waveform of the drive circuit shown in FIG. 5;

FIG. 7 to 10 illustrate different embodiments of a drive circuit of a synchronous motor, according to an embodiment of the present disclosure;

FIG. 11 schematically shows a motor according to an embodiment of the disclosure;

FIG. 12 shows a functional block diagram of a motor driver circuit according to a first preferred embodiment of the disclosure;

FIG. 13 shows a circuit diagram of a motor driver circuit according to a preferred embodiment of the disclosure;

FIG. 14 to FIG. 16 show circuit diagrams of a switch control circuit of a motor driver circuit according to other embodiments of the disclosure;

FIG. 17 shows a circuit diagram of a delay circuit of a motor driver circuit according to another embodiment of the disclosure;

FIG. 18 shows a waveform diagram of a driver circuit as shown in FIG. 12 when a load of a motor is a pure resistive load;

FIG. 19 shows a waveform diagram of a driver circuit when a load of a motor is a inductive load; and

FIG. 20 shows a waveform diagram of counter electromotive force and a winding current in a stator winding of a motor according to an embodiment of the disclosure.

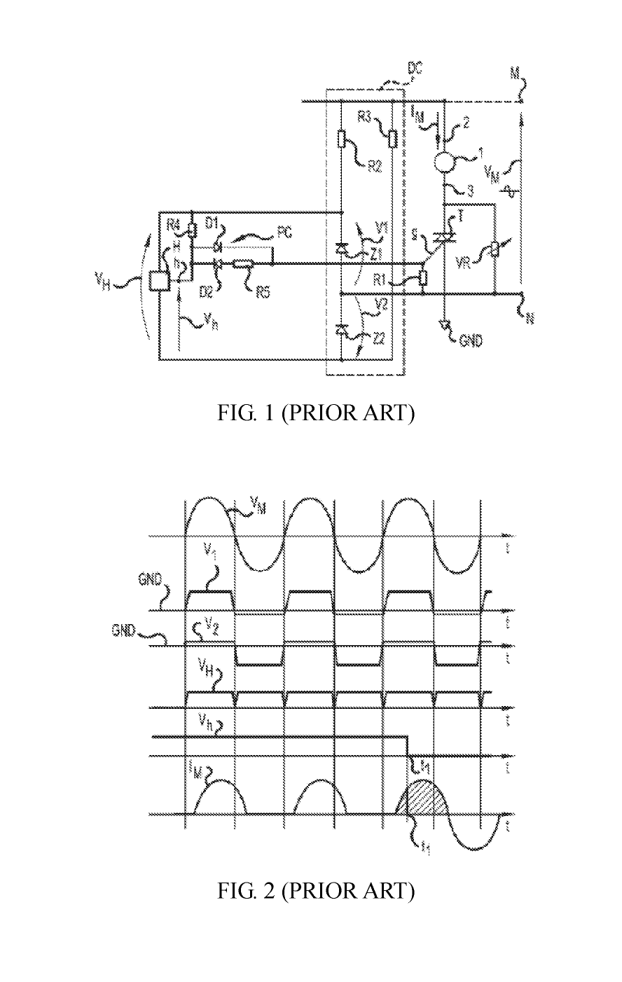

### DETAILED DESCRIPTION

The technical solutions of embodiments of the disclosure will be illustrated clearly and completely in conjunction with the drawings of the embodiments of the disclosure. Apparently, the described embodiments are only a few embodiments rather than all embodiments of the disclosure. Any other embodiments obtained by those skilled in the art on the basis of the embodiments of the present disclosure without creative work will fall within the scope of the present disclosure.

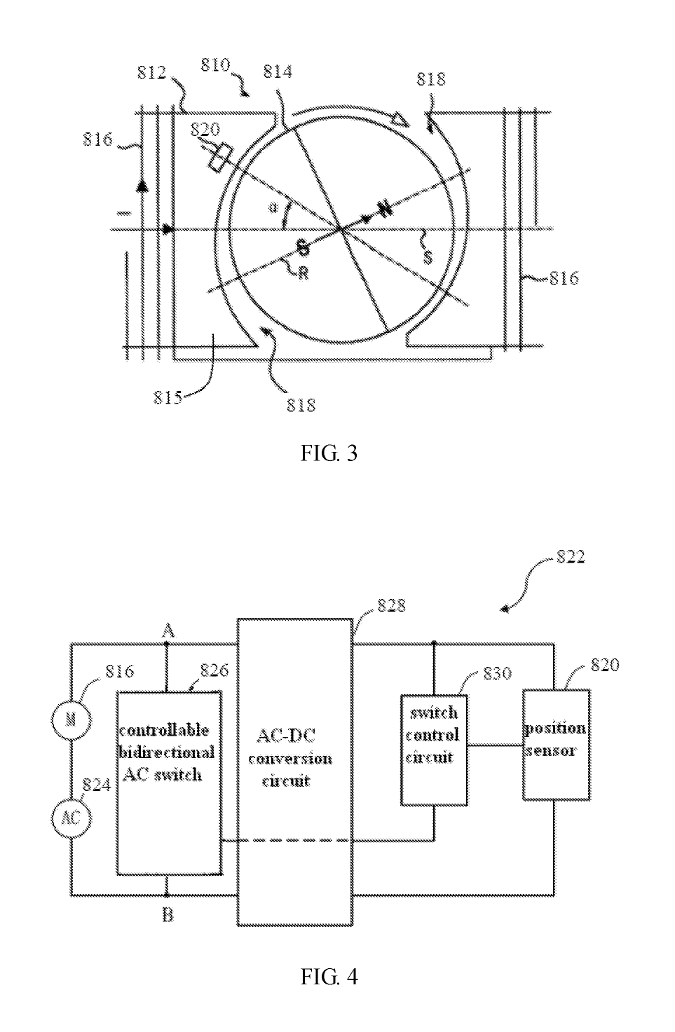

FIG. 3 schematically shows a synchronous motor according to an embodiment of the present invention. The synchronous motor 810 includes a stator 812 and a permanent magnet rotor 814 rotatably disposed between magnetic poles of the stator 812, and the stator 812 includes a stator core 815 and a stator winding 816 wound on the stator core 815. The rotor 814 includes at least one permanent magnet forming at least one pair of permanent magnetic poles with opposite polarities, and the rotor 814 operates at a constant rotational speed of 60 f/p rpm during a steady state phase in a case that the stator winding 816 is connected to an AC power supply, where f is a frequency of the AC power supply and p is the number of pole pairs of the rotor.

Non-uniform gap 818 is formed between the magnetic poles of the stator 812 and the permanent magnetic poles of the rotor 814 so that a polar axis R of the rotor 814 has an angular offset a relative to a central axis S of the stator 812 in a case that the rotor is at rest. The rotor 814 may be configured to have a fixed starting direction (a clockwise direction in this embodiment as shown by the arrow in FIG. 3) every time the stator winding 816 is energized. The stator and the rotor each have two magnetic poles as shown in FIG. 3. It can be understood that, in other embodiments, the stator and the rotor may also have more magnetic poles, such as 4 or 6 magnetic poles.

A position sensor 820 for detecting the angular position of the rotor is disposed on the stator 812 or at a position near the rotor inside the stator, and the position sensor 820 has an angular offset relative to the central axis S of the stator. Preferably, this angular offset is also a, as in this embodiment. Preferably, the position sensor 820 is a Hall effect sensor.

FIG. 4 shows a block diagram of a drive circuit for a synchronous motor according to an embodiment of the present invention. In the drive circuit 822, the stator winding 816 and the AC power supply 824 are connected in series between two nodes A and B. Preferably, the AC power supply 824 may be a commercial AC power supply with a fixed frequency, such as 50 Hz or 60 Hz, and a supply voltage may be, for example, 110V, 220V or 230V. A controllable bidirectional AC switch 826 is connected between the two nodes A and B, in parallel with the stator winding 816 and the AC power supply 824. Preferably, the controllable bidirectional AC switch 826 is a TRIAC, of which two anodes are connected to the two nodes A and B respectively. It can be understood that, the controllable bidirectional AC switch 826 alternatively may be two silicon control rectifiers reversely connected in parallel, and control circuits may be correspondingly configured to control the two silicon control rectifiers in a preset way. An AC-DC conversion circuit 828 is also connected between the two nodes A and B. An AC voltage between the two nodes A and B is converted by the AC-DC conversion circuit 828 into a low voltage DC. The position sensor 820 may be powered by the low voltage DC output by the AC-DC conversion circuit 828, for detecting the magnetic pole position of the permanent magnet rotor 814 of the synchronous motor 810 and outputting a corresponding signal. A switch control circuit 830 is connected to the AC-DC conversion circuit 828, the position sensor 820 and the controllable bidirectional AC switch 826, and is configured to control the controllable bidirectional AC switch 826 to be switched between a switch-on state and a switch-off state in a predetermined way, based on the magnetic pole position of the permanent magnet rotor which is detected by the position sensor and polarity information of the AC power supply 824 which may be obtained from the AC-DC conversion circuit 828, such that the stator winding 816 urges the rotor 814 to rotate only in the above-mentioned fixed starting direction during a starting phase of the motor.

According to this embodiment of the present invention, in a case that the controllable bidirectional AC switch 826 is switched on, the two nodes A and B are shorted, the AC-DC conversion circuit 828 does not consume electric energy since there is no current flowing through the AC-DC conversion circuit 828, hence, the utilization efficiency of electric energy can be improved significantly.

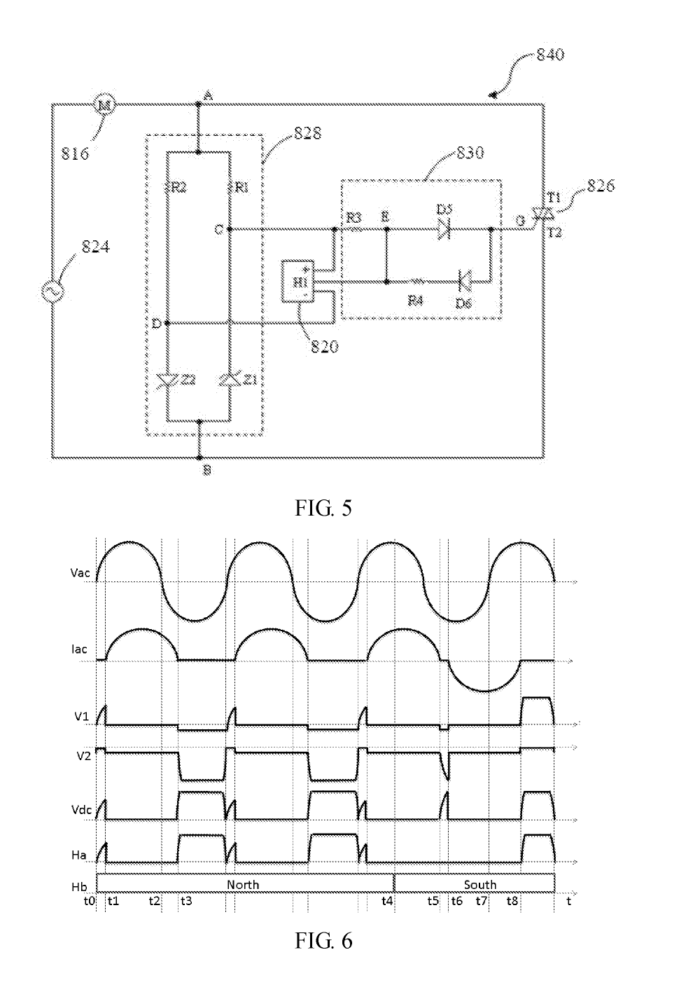

FIG. 5 shows a circuit diagram of a drive circuit 840 for a synchronous motor according to a first embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC (preferably, low voltage ranges from 3V to 18V). The AC-DC conversion circuit 828 includes a first zener diode Z1 and a second zener diode Z2 which are reversely connected in parallel between the two nodes A and B via a first resistor R1 and a second resistor R2 respectively. A high voltage output terminal C of the AC-DC conversion circuit 828 is formed at a connection point of the first resistor R1 and a cathode of the first zener diode Z1, and a low voltage output terminal D of the AC-DC conversion circuit 828 is formed at a connection point of the second resistor R2 and an anode of the second zener diode Z2. The voltage output terminal C is connected to a positive power supply terminal of the position sensor 820, and the voltage output terminal D is connected to a negative power supply terminal of the position sensor 820. Three terminals of the switch control circuit 830 are connected to the high voltage output terminal C of the AC-DC conversion circuit 828, an output terminal H1 of the position sensor 820 and a control electrode G of the TRIAC 826 respectively. The switch control circuit 830 includes a third resistor R3, a fifth diode D5, and a fourth resistor R4 and a sixth diode D6 connected in series between the output terminal HI of the position sensor 820 and the control electrode G of the controllable bidirectional AC switch 826. An anode of the sixth diode D6 is connected to the control electrode G of the controllable bidirectional AC switch 826. One terminal of the third resistor R3 is connected to the high voltage output terminal C of the AC-DC conversion circuit 828, and the other terminal of the third resistor R3 is connected to an anode of the fifth diode D5. A cathode of the fifth diode D5 is connected to the control electrode G of the controllable bidirectional AC switch 826.

In conjunction with FIG. 6, an operational principle of the drive circuit 840 is described. In FIG. 6, Vac indicates a waveform of voltage of the AC power supply 824, and lac indicates a waveform of current flowing through the stator winding 816. Due to the inductive character of the stator winding 816, the waveform of current Iac lags behind the waveform of voltage Vac. V1 indicates a waveform of voltage between two terminals of the first zener diode Z1, V2 indicates a waveform of voltage between two terminals of the second zener diode Z2, Vdc indicates a waveform of voltage between two output terminals C and D of the AC-DC conversion circuit 828, Ha indicates a waveform of a signal output by the output terminal H1 of the position sensor 820, and Hb indicates a rotor magnetic field detected by the position sensor 820. In this embodiment, in a case that the position sensor 820 is powered normally, the output terminal HI outputs a logic high level in a case that the detected rotor magnetic field is North, or the output terminal H1 outputs a logic low level in a case that the detected rotor magnetic field is South.

In a case that the rotor magnetic field Hb detected by the position sensor 820 is North, in a first positive half cycle of the AC power supply, the supply voltage is gradually increased from a time instant t0 to a time instant t1, the output terminal H1 of the position sensor 820 outputs a high level, and a current flows through the resistor R1, the resistor R3, the diode D5 and the control electrode G and the second anode T2 of the TRIAC 826 sequentially. The TRIAC 826 is switched on in a case that a drive current flowing through the control electrode G and the second anode T2 is greater than a gate triggering current Ig. Once the TRIAC 826 is switched on, the two nodes A and B are shorted, a current flowing through the stator winding 816 in the motor is gradually increased until a large forward current flows through the stator winding 816 to drive the rotor 814 to rotate clockwise as shown in FIG. 3. Since the two nodes A and B are shorted, there is no current flowing through the AC-DC conversion circuit 28 from the time instant t1 to a time instant t2. Hence, the resistors R1 and R2 do not consume electric energy, and the output of the position sensor 820 is stopped due to no power is supplied. Since the current flowing through two anodes T1 and T2 of the TRIAC 826 is large enough (which is greater than a holding current Ihold), the TRIAC 826 is kept to be switched on in a case that there is no drive current flowing through the control electrode G and the second anode T2. In a negative half cycle of the AC power supply, after a time instant t3, a current flowing through T1 and T2 is less than the holding current Ihold, the TRIAC 826 is switched off, a current begins to flow through the AC-DC conversion circuit 828, and the output terminal HI of the position sensor 820 outputs a high level again. Since a potential at the point C is lower than a potential at the point E, there is no drive current flowing through the control electrode G and the second anode T2 of the TRIAC 826, and the TRIAC 826 is kept to be switched off. Since the resistance of the resistors R1 and R2 in the AC-DC conversion circuit 828 are far greater than the resistance of the stator winding 816 in the motor, a current currently flowing through the stator winding 816 is far less than the current flowing through the stator winding 816 from the time instant t1 to the time instant t2 and generates very small driving force for the rotor 814. Hence, the rotor 814 continues to rotate clockwise due to inertia. In a second positive half cycle of the AC power supply, similar to the first positive half cycle, a current flows through the resistor R1, the resistor R3, the diode D5, and the control electrode G and the second anode T2 of the TRIAC 826 sequentially. The TRIAC 826 is switched on again, and the current flowing through the stator winding 816 continues to drive the rotor 814 to rotate clockwise. Similarly, the resistors R1 and R2 do not consume electric energy since the two nodes A and B are shorted. In the next negative half cycle of the power supply, the current flowing through the two anodes T1 and T2 of the TRIAC 826 is less than the holding current Ihold, the TRIAC 826 is switched off again, and the rotor continues to rotate clockwise due to the effect of inertia.

At a time instant t4, the rotor magnetic field Hb detected by the position sensor 820 changes to be South from North, the AC power supply is still in the positive half cycle and the TRIAC 826 is switched on, the two nodes A and B are shorted, and there is no current flowing through the AC-DC conversion circuit 828. After the AC power supply enters the negative half cycle, the current flowing through the two anodes T1 and T2 of the TRIAC 826 is gradually decreased, and the TRIAC 826 is switched off at a time instant t5. Then the current flows through the second anode T2 and the control electrode G of the TRIAC 826, the diode D6, the resistor R4, the position sensor 820, the resistor R2 and the stator winding 816 sequentially. As the drive current is gradually increased, the TRIAC 826 is switched on again at a time instant t6, the two nodes A and B are shorted again, the resistors RI and R2 do not consume electric energy, and the output of the position sensor 820 is stopped due to no power is supplied. There is a larger reverse current flowing through the stator winding 816, and the rotor 814 continues to be driven clockwise since the rotor magnetic field is South. From the time instant t5 to the time instant t6, the first zener diode Z1 and the second zener diode Z2 are switched on, hence, there is a voltage output between the two output terminals C and D of the AC-DC conversion circuit 828. At a time instant t7, the AC power supply enters the positive half cycle again, the TRIAC 826 is switched off when the current flowing through the TRIAC 826 crosses zero, and then a voltage of the control circuit is gradually increased. As the voltage is gradually increased, a current begins to flow through the AC-DC conversion circuit 828, the output terminal H1 of the position sensor 820 outputs a low level, there is no drive current flowing through the control electrode G and the second anode T2 of the TRIAC 826, hence, the TRIAC 826 is switched off Since the current flowing through the stator winding 816 is very small, nearly no driving force is generated for the rotor 814. At a time instant t8, the power supply is in the positive half cycle, the position sensor outputs a low level, the TRIAC 826 is kept to be switched off after the current crosses zero, and the rotor continues to rotate clockwise due to inertia. According to an embodiment of the present invention, the rotor may be accelerated to be synchronized with the stator after rotating only one circle after the stator winding is energized.

In the embodiment of the present invention, by taking advantage of a feature of a TRIAC that the TRIAC is kept to be switched on although there is no drive current flowing though the TRIAC once the TRIAC is switched on, it is avoided that a resistor in the AC-DC conversion circuit still consumes electric energy after the TRIAC is switched on, hence, the utilization efficiency of electric energy can be improved significantly.

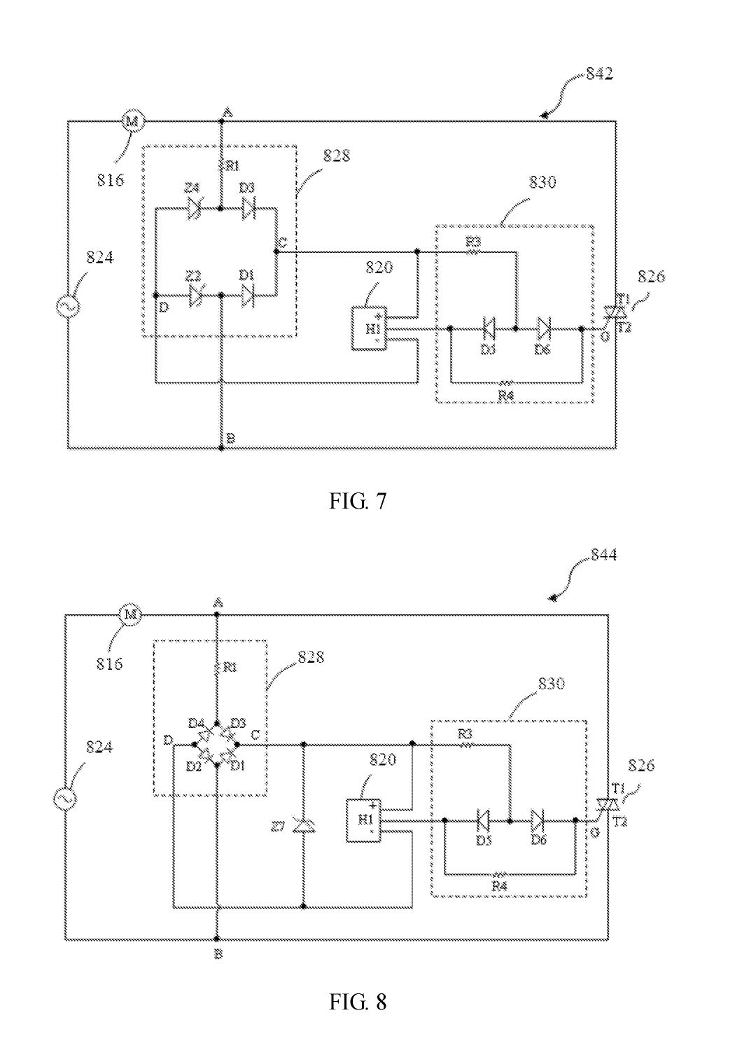

FIG. 7 shows a circuit diagram of a drive circuit 842 for a synchronous motor according to an embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the AC-DC conversion circuit 828 is formed at a connection point of a cathode of the first diode D1 and a cathode of the third diode D3, and the low voltage output terminal D of the AC-DC conversion circuit 828 is formed at a connection point of an anode of the second zener diode Z2 and an anode of the fourth zener diode Z4. The output terminal C is connected to a positive power supply terminal of the position sensor 820, and the output terminal D is connected to a negative power supply terminal of the position sensor 820. The switch control circuit 30 includes a third resistor R3, a fourth resistor R4, and a fifth diode D5 and a sixth diode D6 reversely connected in series between the output terminal H1 of the position sensor 820 and the control electrode G of the controllable bidirectional AC switch 826. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the AC-DC conversion circuit, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

FIG. 8 shows a circuit diagram of a drive circuit 844 for a synchronous motor according to a further embodiment of the present invention. The drive circuit 844 is similar to the drive circuit 842 in the previous embodiment and, the drive circuit 844 differs from the drive circuit 842 in that, the zener diodes Z2 and Z4 in the drive circuit 842 are replaced by general diodes D2 and D4 in the rectifier of the drive circuit 844. In addition, a zener diode Z7 is connected between the two output terminals C and D of the AC-DC conversion circuit 828 in the drive circuit 844.

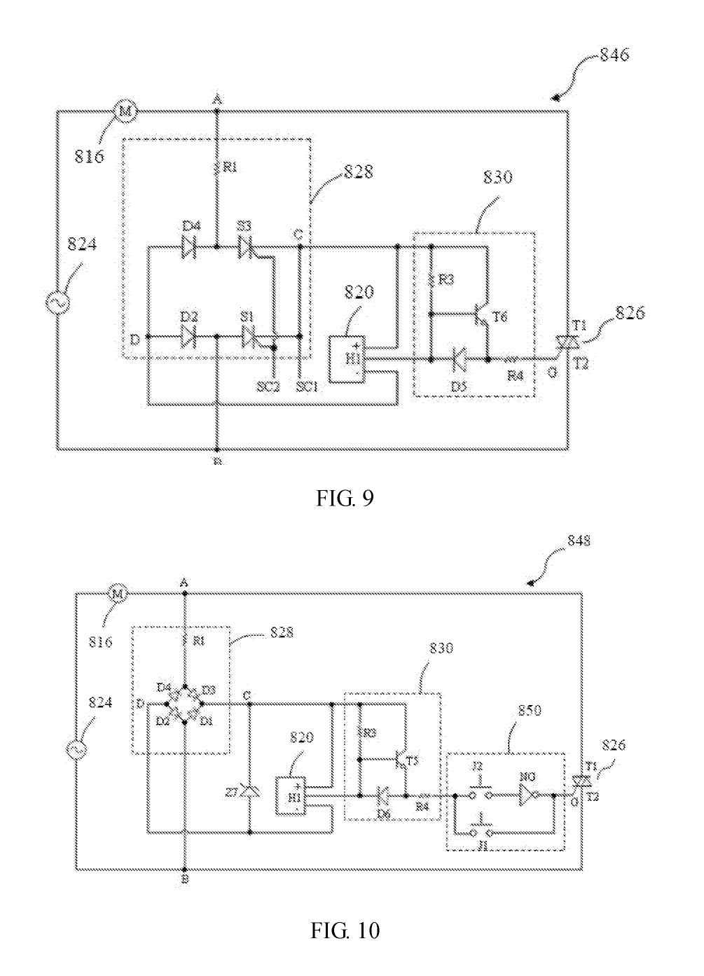

FIG. 9 shows a circuit diagram of a drive circuit 846 for a synchronous motor according to further embodiment of the present invention. The stator winding 816 of the synchronous motor is connected in series with the AC power supply 824 between the two nodes A and B. A first anode Ti of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes two silicon control rectifiers S1 and S3 reversely connected in series, and the other of the two rectifier branches includes a second diode D2 and a fourth diode D4 reversely connected in series. The high voltage output terminal C of the AC-DC conversion circuit 828 is formed at a connection point of a cathode of the silicon control rectifier Si and a cathode of the silicon control rectifier S3, and the low voltage output terminal D of the AC-DC conversion circuit 828 is formed at a connection point of an anode of the second diode D2 and an anode of the fourth diode D4. The output terminal C is connected to a positive power supply terminal of the position sensor 820, and the output terminal D is connected to a negative power supply terminal of the position sensor 820. The switch control circuit 830 includes a third resistor R3, an NPN transistor T6, and a fourth resistor R4 and a fifth diode D5 connected in series between the output terminal H1 of the position sensor 820 and the control electrode G of the controllable bidirectional AC switch 826. A cathode of the fifth diode D5 is connected to the output terminal H1 of the position sensor. One terminal of the third resistor R3 is connected to the high voltage output terminal C of the AC-DC conversion circuit, and the other terminal of the third resistor R3 is connected to the output terminal H1 of the position sensor. A base of the NPN transistor T6 is connected to the output terminal H1 of the position sensor, an emitter of the NPN transistor T6 is connected to an anode of the fifth diode D5, and a collector of the NPN transistor T6 is connected to the high voltage output terminal C of the AC-DC conversion circuit.

In this embodiment, a reference voltage may be input to the cathodes of the two silicon control rectifiers S1 and S3 via a terminal SC1, and a control signal may be input to control terminals of S1 and S3 via a terminal SC2. The rectifiers Si and S3 are switched on in a case that the control signal input from the terminal SC2 is a high level, or are switched off in a case that the control signal input from the terminal SC2 is a low level. Based on the configuration, the rectifiers S1 and S3 may be switched between a switch-on state and a switch-off state in a preset way by inputting the high level from the terminal SC2 in a case that the drive circuit operates normally. The rectifiers S1 and S3 are switched off by changing the control signal input from the terminal SC2 from the high level to the low level in a case that the drive circuit fails. In this case, the TRIAC 826, the conversion circuit 828 and the position sensor 820 are switched off, to ensure the whole circuit to be in a zero-power state.

FIG. 10 shows a circuit diagram of a drive circuit 848 for a synchronous motor according to another embodiment of the present invention. The drive circuit 848 is similar to the drive circuit 846 in the previous embodiment and, the drive circuit 848 differs from the drive circuit 846 in that, the silicon control diodes S1 and S3 in the drive circuit 846 are replaced by general diodes D1 and D3 in the rectifier of the drive circuit 848, and a zener diode Z7 is connected between the two terminals C and D of the AC-DC conversion circuit 828. In addition, in the drive circuit 848 according to the embodiment, a preset steering circuit 850 is disposed between the switch control circuit 30 and the TRIAC 826. The preset steering circuit 850 includes a first jumper switch J1, a second jumper J2 switch and an inverter NG connected in series with the second jumper switch J2. Similar to the drive circuit 846, in this embodiment, the switch control circuit 830 includes the resistor R3, the resistor R4, the NPN transistor T5 and the diode D6. One terminal of the resistor R4 is connected to a connection point of an emitter of the transistor T5 and an anode of the diode D6, and the other terminal of the resistor R4 is connected to one terminal of the first jumper switch J1, and the other terminal of the first jumper switch J1 is connected to the control electrode G of the TRIAC 826, and the second jumper switch J2 and the inverter NG connected in series are connected across two terminals of the first jumper switch J1. In this embodiment, when the first jumper switch J1 is switched on and the second jumper switch J2 is switched off, similar to the above embodiments, the rotor 814 still starts clockwise; when the second jumper switch J2 is switched on and the first jumper switch J1 is switched off, the rotor 814 starts counterclockwise. In this case, a starting direction of the rotor in the motor may be selected by selecting one of the two jumper switches to be switched on and the other to be switched off. Therefore, in a case that a driving motor is needed to be supplied for different applications having opposite rotational directions, it is just needed to select one of the two jumper switches J1 and J2 to be switched on and the other to be switched off, and no other changes need to be made to the drive circuit, hence, the drive circuit according to this embodiment has good versatility.

As discussed above, the position sensor 820 is configured for detecting the magnetic pole position of the permanent magnet rotor 814 of the synchronous motor 810 and outputting a corresponding signal. The output signal from the position sensor 820 represents some characteristics of the magnetic pole position such as the polarity of the magnetic field associated with the magnetic pole position of the permanent magnet rotor 814 of the synchronous motor 810. The detected magnetic pole position is then used, by the switch control circuit 830, control the controllable bidirectional AC switch 824 to be switched between a switch-on state and a switch-off state in a predetermined way, based on, together with the magnetic pole position of the permanent magnet rotor, the polarity information of the AC power supply 824 which may be obtained from the AC-DC conversion circuit 828. It should be appreciated that the switch control circuit 830 and the position sensor 820 can be realized via magnetic sensing. Accordingly, the present disclosure discloses a magnetic sensor integrated circuit for magnetic sensing and control of a motor according to the sensed information.

The magnetic sensor integrated circuit according to the present disclosure includes a magnetic field detecting circuit that can reliably detect a magnetic field and generate a magnetic induction signal indicative of certain characteristics of the magnetic field. The magnetic sensor as disclosed herein also includes an output control circuit that controls the magnetic sensor to operate in a state determined with respect to the polarity of the magnetic field as well as that of an AC power supply. In the case the magnetic sensor integrated circuit is coupled with the bidirectional AC switch, the magnetic sensor integrated circuit can effectively regulate the operation of the motor via the bidirectional AC switch. Further, the magnetic sensor integrated circuit in the present disclosure may be directly connected to a commercial/residential AC power supply with no need for any additional A/D converting equipment. In this way, the present disclosure of the magnetic sensor integrated circuit is suitable to be used in a wide range of applications.

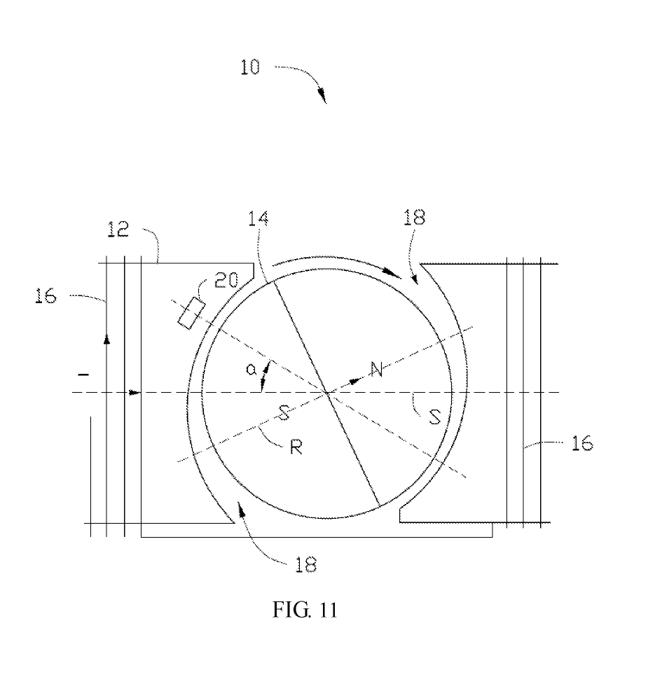

FIG. 11 schematically shows a motor 10 in the disclosure. The. motor 10 described by taking a synchronous motor as an example. The motor 10 includes a stator and a rotor 14 rotatably disposed between magnetic poles of the stator. The stator includes a stator magnetic core 12 and a stator winding 16 wound around the stator magnetic core. The rotor 14 is a permanent magnet rotor.

Preferably, a non-uniform air gap 18 is disposed between the magnetic pole of the stator and the magnetic pole of the rotor 14, and the polar axis R of the rotor 14 relative to the polar axis S of the stator has an offset angle α when the rotor 14 rests. This configuration can ensure that the rotor 14 has a fixed starting direction (in this example, a clockwise direction) every time the stator winding 16 is energized. The polar axis R of the rotor refers to a virtual connecting line through centers of two symmetric magnetic poles (in the embodiment, two magnets) along a diameter direction of the rotor; and the polar axis S of the stator refers to a virtual connecting line through centers of two symmetric pole portions along a diameter direction of the stator. In FIG. 11, both the stator and the rotor have two magnetic poles, the non-uniform air gap 18 between the magnetic pole of the stator and the magnetic pole of the rotor 14 decreases gradually along the starting direction of the rotor. In another embodiment, a pole cambered surface of the pole portion of the stator can be disposed concentric with the rotor so as to form a main air gap with an equal space; and an inward concave starting groove is disposed on the pole cambered surface so that the non-uniform air gap with an unequal space is formed between the starting groove and the external surface of the rotor. It may be understood that, in more embodiments, the rotor and the stator may have more magnetic poles, such as four or six magnetic poles.

The position sensor 20 is disposed on the stator or inside the stator near the rotor 14. The position sensor 20 is configured to detect a position of the magnetic pole of the rotor, and the position sensor 20 deviates for an angle relative to the pole axis S of the stator. The preferred deviation angle in the embodiment is also α.

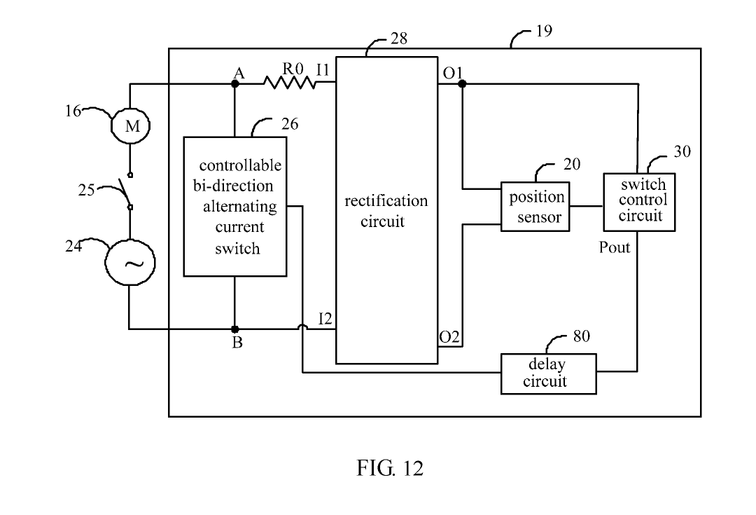

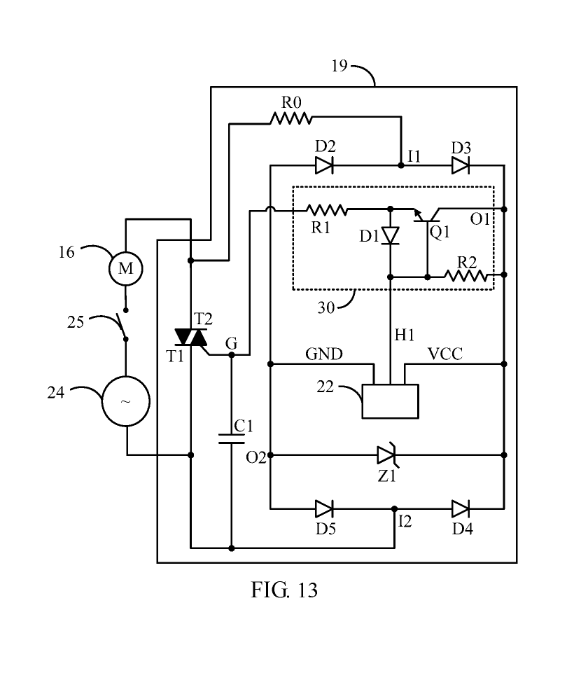

FIG. 12 shows a block diagram of a motor driver circuit 19 of the motor according to an embodiment of the disclosure. The motor driver circuit 19 includes a position sensor 20, a rectification circuit 28, a controllable bi-direction alternating current switch 26, a switch control circuit 30 and a delay circuit 80. A stator winding 16 of the motor and the controllable bi-direction alternating current switch 26 are connected in series between two terminals of an alternating current power source 24. A power switch 25 configured to control the motor to start or stop is disposed between the stator winding 16 and the alternating current power source 24. The rectification circuit 28 is configured to convert the alternating current power source into a low voltage direct current and supply the low voltage direct current to the position sensor 20. The position sensor 20 is supplied by the low voltage direct current outputted by the rectification circuit 28, and the position sensor 20 is configured to detect a position of the magnetic pole of the rotor 14 of the motor and output a magnetic induction signal at an output terminal of the position sensor 20. The switch control circuit 30 is connected to the rectification circuit 28 and the position sensor 20. The output terminal Pout of the switch control circuit 30 is connected to the controllable bi-direction alternating current switch 26 via the delay circuit 80. The switch control circuit 30 is configured to control the controllable bi-direction alternating current switch 26 to be turned on or turned off in a preset manner, based on position information of the magnetic pole of the rotor detected by the position sensor 20 and polarity information of the alternating current power source 24, to cause the stator winding 16 to drag the rotor 14 to rotate along the above-mentioned fixed starting direction.

The external alternating current power source 24 may be 220V or 230V alternating current of a commercial power, or an alternating current outputted by an inverter. Preferably, the controllable bi-direction alternating current switch 26 may be a bidirectional triode thyristor (TRIAC). Preferably, the position sensor 20 may be a Hall sensor 22 (shown as FIG. 13).

In the FIG. 12, the controllable bi-direction alternating current switch 26 is connected between a first node A and a second node B, and the stator winding 16 and the alternating current power source 24 are connected in series between the first node A and the second node B. In another embodiment, the stator winding 16 and the controllable bi-direction alternating current switch 26 are connected in series between the first node A and the second node B, and two terminals of the alternating current power source 24 are connected to the first node A and the second node B respectively. In this way, the stator winding 16 of the motor and the controllable bi-direction alternating current switch 26 are connected in series between two terminals of the alternating current power source 24. A first input terminal I1 and a second input terminal I2 of the rectification circuit 28 are connected to the first node A and the second node B, respectively. Preferably, the first input terminal I1 is connected to the first node A via a resistor R0.

Reference is made to FIG. 13, which is a specific circuit diagram of a motor driver circuit 19 as shown in FIG. 12 according to a first embodiment.

The rectification circuit 28 includes four diodes D2 to D5. A cathode of the diode

D2 is connected to an anode of the diode D3; an cathode of the diode D3 is connected to an cathode of the diode D4; an anode of the diode D4 is connected to an cathode of the diode D5; and an anode of the diode D5 is connected to an anode of the diode D2. The cathode of the diode D2 as the first input terminal I1 of the rectification circuit 28 is connected to the stator winding 16 of the motor 10 via the resistor R0. The anode of the diode D4 as the second input terminal I2 of the rectification circuit 28 is connected to the alternating current power source 24. The cathode of the diode D3 as a first output terminal O1 of the rectification circuit 28 is connected to the Hall sensor 22 and the switch control circuit 30, and the first output terminal O1 outputs a high direct current operating voltage. The anode of the diode D5 as a second output terminal O2 of the rectification circuit 28 is connected to the Hall sensor 22, and the second output terminal O2 outputs a low voltage lower than the voltage outputted by the first output terminal. A voltage regulator circuit such as a zener diode Z1 is connected between the first output terminal O1 and the second output terminal O2 of the rectification circuit 28. The anode of the zener diode Z1 is connected to the second output terminal O2; and the cathode of the zener diode Z1 is connected to the first output terminal O1.

In the embodiment, the Hall sensor 22 includes a power source terminal VCC, a ground terminal GND and an output terminal H1. The power source terminal VCC is connected to the first output terminal O1 of the rectification circuit 28; the ground terminal GND is connected to the second output terminal O2 of the rectification circuit 28; and the output terminal H1 is connected to the switch control circuit 30. In a case that the Hall sensor 22 is supplied normally, that is, the power source terminal VCC receives a high voltage and the ground terminal GND receives a low voltage, the output terminal H1 of the Hall sensor 22 outputs a magnetic induction signal corresponding to a logic high level in a case that the detected magnetic field of the rotor is north pole (North); and the output terminal H1 of the Hall sensor 22 outputs a magnetic induction signal corresponding to a logic low level in a case that the detected magnetic field of the rotor is south pole (South).

In a preferred embodiment, the switch control circuit 30 includes a first switch and a second switch. The first switch is connected in a first current path, and the first current path is disposed between a control terminal of the controllable bi-direction alternating current switch 26 (connecting to the output terminal Pout of the switch control circuit 30) and the first output terminal O1 of the rectification circuit 28. The second switch is connected in a second current path, and the second current path is disposed between the control terminal of the controllable bi-direction alternating current switch 26 and the second output terminal O2 of the rectification circuit 28.

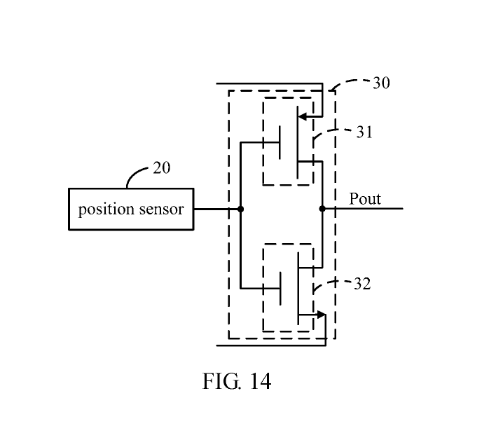

As a particular implementation, as shown in FIG. 14, a first switch 31 and a second switch 32 are a pair of complementary semiconductor switches. The first switch 31 is turned on at a low level, and the second switch 32 is turned on at a high level. The first switch 31 and the output terminal Pout of the switch control circuit 30 are connected in the first current path. The second switch 32 and the output terminal Pout are connected in the second current path. Control terminals of both the first switch 31 and the second switch 32 are connected to the position sensor 20. A current input terminal of the first switch 31 is connected to a high voltage (such as a direct current power supply); a current output terminal is connected to the current input terminal of the second switch 32; and the current output terminal of the second switch 32 is connected to a low voltage (such as a ground). In a case that the magnetic induction signal outputted by the position sensor 20 is at a low level, the first switch 31 is turned on, and the second switch 32 is turned off, a load current flows from a high voltage via the first switch 31 and the output terminal Pout of the switch control circuit 30 to the outside. In a case that the magnetic induction signal outputted by the position sensor 20 is at a high level, the second switch 32 is turned on, and the first switch 31 is turned off, the load current flows from the outside into the output terminal Pout and flows through the second switch 32. In the instance shown in FIG. 14, the first switch 31 is a positive channel metal-oxide semiconductor field effect transistor (P-type MOSFET), and the second switch 32 is a negative channel metal-oxide semiconductor field effect transistor (N-type MOSFET). It can be understood that the first switch 31 and the second switch 32 in another embodiment may be other types of semiconductor switches, such as a junction field-effect transistor (JFET) or a metal semiconductor field-effect transistor (MESFET) or other field-effect transistors.

A delay circuit 80 is disposed between the output terminal Pout of the switch control circuit 30 and the control terminal G of the controllable bi-direction alternating current switch 26. Preferably, the delay circuit is a RC delay circuit.

In another specific instance, referring to FIG. 13, the switch control circuit 30 includes a first terminal, a second terminal and a third terminal. The first terminal is connected to a first output terminal O1 of the rectification circuit 28; the second terminal is connected to an output terminal H1 of the Hall sensor 22; and the third terminal is connected to a control terminal of the controllable bi-direction alternating current switch 26. The switch control circuit 30 includes a resistor R2, a NPN triode Q1 (a first switch), a diode D1 (a second switch) connected in series between the output terminal H1 of the Hall sensor 22 and the controllable bi-direction alternating current switch 26, and a resistor R1. The cathode of the diode D1 as the second terminal is connected to the output terminal H1 of the Hall sensor 22. One terminal of the resistor R2 is connected to the first output terminal O1 of the rectification circuit 28, and the other terminal of the resistor R2 is connected to the output terminal H1 of the Hall sensor 22. A base of the NPN triode Q1 is connected to the output terminal H1 of the Hall sensor 22; an emitter of the NPN triode Q1 is connected to the anode of the diode D1; and a collector of the NPN triode Q1 as the first terminal is connected to the first output terminal O1 of the rectification circuit 28. The terminal of the resistor R1 not connected to the diode D1 functions as the third terminal.

Preferably, the controllable bi-direction alternating current switch 26 is a bidirectional triode thyristor (TRIAC). Two anodes T1 and T2 of the TRIAC are connected to the alternating current power source 24 and the stator winding 16 respectively, and a control terminal G of the TRIAC is connected to the third terminal of the switch control circuit 30. The delay circuit may be a RC delay circuit, which includes a capacitor C1 and a resistor R1. The capacitor C1 is connected between the control terminal G of the TRIAC and a first anode T1. In this embodiment, the RC delay circuit is formed by the resistor R1 of the switch control circuit 30 and the capacitor C1.

As can be understood, the controllable bi-direction alternating current switch 26 may include an electronic switch through which a current can flow in both directions formed by one or more of a metal-oxide semiconductor field effect transistor, a silicon-controlled alternating current-direct current converting circuit, a bidirectional triode thyristor, an insulated gate bipolar transistor, a bipolar junction transistor, a semiconductor thyratron, and optocouplers. For example, two metal-oxide semiconductor field effect transistors may form the controllable bi-direction alternating current switch; two silicon-controlled alternating current-direct current converting circuits may form the controllable bi-direction alternating current switch; two insulated gate bipolar transistors may form the controllable bi-direction alternating current switch; and two bipolar junction transistors may form the controllable bi-direction alternating current switch.

In another embodiment, the switch control circuit 30 includes: a first current path in which a current flows to a control terminal of the controllable bi-direction alternating current switch 26; a second current path in which a current flows from the control terminal of the controllable bi-direction alternating current switch 26; and a switch connected in one of the first current path and the second current path. The switch is controlled by the magnetic induction signal to make the first current path and the second current path to be turned on selectively. Optionally, the other one of the first current path and the second current path does not include a switch.

As a specific implementation, as shown in FIG. 15, the switch control circuit 30 includes a unidirectional switch 33. The unidirectional switch 33 and the output terminal Pout are connected in the first current path. A current input terminal of the unidirectional switch 33 may be connected to the output terminal of the position sensor 20. The output terminal of the position sensor 20 may also be connected to the output terminal Pout through a resistor R4 in the second current path having a direction opposite to a direction of the first current path. The unidirectional switch 33 is turned on in a case that the magnetic induction signal is at a high level, and a load current flows to the outside through the unidirectional switch 33 and the output terminal Pout. The unidirectional switch 33 is turned off in a case that the magnetic induction signal is at a low level, and the load current flows into the output terminal Pout from the outside and flows through the resistor R4 and the position sensor 20. Alternatively, the resistor R4 in the second current path may be replaced by another unidirectional switch connected in parallel reversely to the unidirectional switch 33. In this way, the load current flowing out from the output terminal Pout is more balanced with the load current flowing into the output terminal Pout.

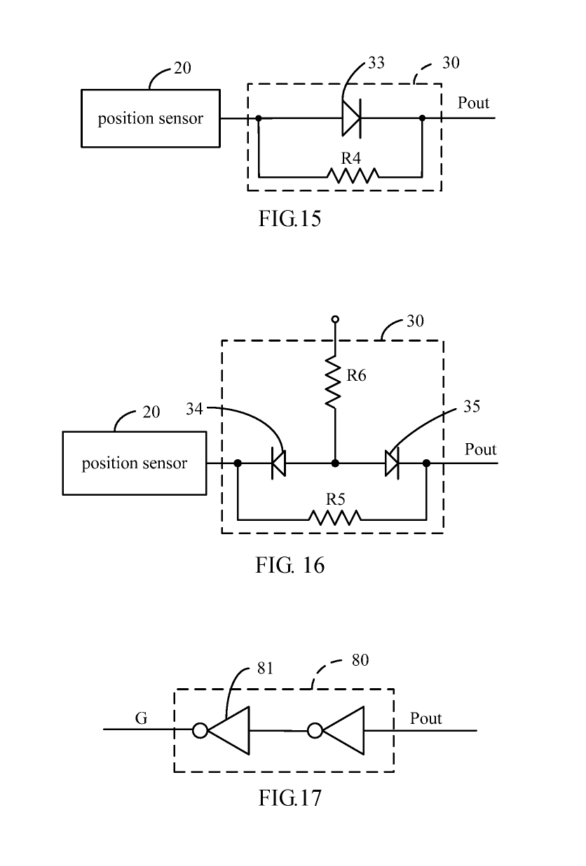

In another specific implementation, as shown in FIG. 16, the switch control circuit 30 includes a diode 34 and a diode 35 connected in series reversely between the output terminal of the position sensor 20 and the output terminal Pout, a resistor R5 connected in parallel to the diode 34 and the diode 35 which are connected in series, and a resistor R6 connected between a common terminal of the diode 34 and the diode 35 and a power source. The cathode of the diode 34 is connected to the output terminal of the position sensor 20. The power source may be connected to the first output terminal O1 of the rectification circuit 28. The diode 34 is controlled by the magnetic induction signal. In a case that the magnetic induction signal is at the high level, the diode 34 is turned off, and the load current flows from the output terminal Pout to the outside through the resistor R6 and the diode 35. In a case that the magnetic induction signal is at the low level, the load current flows from the outside into the output terminal Pout and flows through the resistor R5 and the position sensor 20.

A delay circuit 80 is disposed between the output terminal Pout of the switch control circuit 30 and the control terminal G of the controllable bi-direction alternating current switch 26. Preferably, the delay circuit is a RC delay circuit. In other embodiments, referring to FIG. 17, the delay circuit 80 may be formed in other manner. For example, the delay circuit includes an even number of NOT gates 81.

The switch control circuit 30 is configured to: control the controllable bi-direction alternating current switch 26 to be turned on, in a case that the alternating current power source is in a positive half cycle and the position sensor 20 detects that a magnetic field polarity of a rotor is a first polarity, or in a case that the alternating current power source is in a negative half cycle and the position sensor detects that the magnetic field polarity of the rotor is a second polarity opposite to the first polarity; and control the controllable bi-direction alternating current switch 26 to be turned off, in a case that the alternating current power source is in the negative half cycle and the position sensor 20 detects that the magnetic field polarity of the rotor is the first polarity, or in a case that the alternating current power source is in the positive half cycle and the position sensor detects that the magnetic field polarity of the rotor is the second polarity. In this embodiment, the first polarity is N pole; and the second polarity is S pole. In other embodiments, the first polarity is S pole; and the second polarity is N pole.

In a case that the controllable bi-direction alternating current switch 26 is turned on, the switch control circuit 30 switches between a first state in which a current flows from a first output terminal O1 of the rectification circuit 28 to the control terminal of the controllable bi-direction alternating current switch 26 and a second state in which a current flows from the control terminal of the controllable bi-direction alternating current switch 26 to a second output terminal O2 of the rectification circuit 28. It should be noted that, in the embodiments of the present disclosure, the switching of operation state of the switch control circuit 30 between the first state and the second state is not limited to the case of immediately switching to one state after the other state ends, further including the case of switching to one state after an interval time following the other state elapses. In a preferred application, no drive current flows through the control terminal of the controllable bi-direction alternating current switch 26 during the interval time for switching between the first state and the second state.

Specifically, in a case that the alternating current power source 24 is in a positive half cycle and the position sensor 20 detects that a magnetic field polarity of the rotor is a first polarity, the switch control circuit 30 makes the drive current flow from the first output terminal O1 of the rectification circuit 28 to the control terminal of the controllable bi-direction alternating current switch 26. In a case that the alternating current power source 24 is in the negative half cycle and the position sensor 20 detects that the magnetic field polarity of the rotor is a second polarity, the switch control circuit 30 makes the drive current flow from the control terminal of the controllable bi-direction alternating current switch 26 to the second output terminal O2 of the rectification circuit 28.

As can be appreciated, the situation of the drive current flowing through the control terminal of the controllable bi-direction alternating current switch 26 in a case that the magnetic field polarity of the rotor is the first polarity and the alternating current power source is in a positive half cycle or in a case that the magnetic field polarity of the rotor is the second polarity and the alternating current power source is in a negative half cycle includes both a situation that a current flows through the control terminal of the controllable bi-direction alternating current switch 26 for the whole duration of either of the above two cases, and a situation that a current flows through the control terminal of the controllable bi-direction alternating current switch 26 for a part of duration of either of the above two cases.

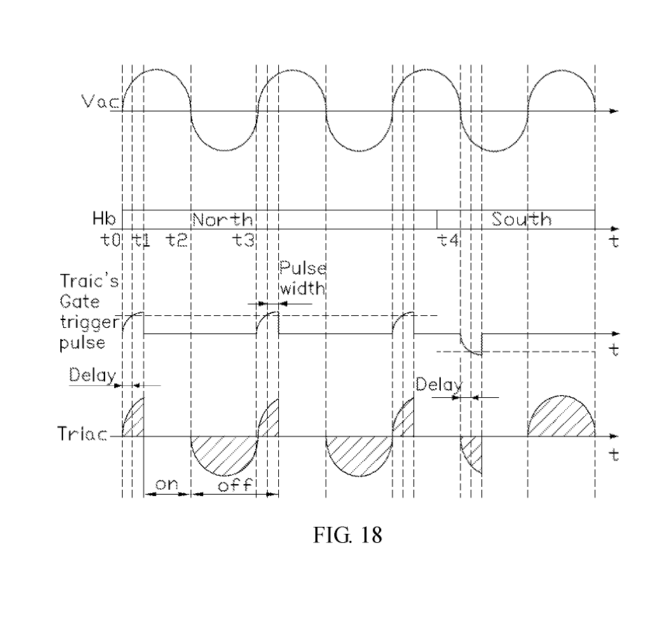

The operating principle of the motor driver circuit 19 is described in conjunction of FIG. 18.

“Vac” in FIG. 18 represents a voltage waveform of the external alternating current power source 24, “Hb” represents a position of the magnetic pole of the rotor detected by the position sensor 20, “Triac” represents a turn-on state and a turn-off state of the controllable bi-direction alternating current switch 26, where “on” represents the controllable bi-direction alternating current switch 26 is turned on, and “off” represents the controllable bi-direction alternating current switch 26 is turned off (corresponding to the part of the waveform indicated with a diagonal line).

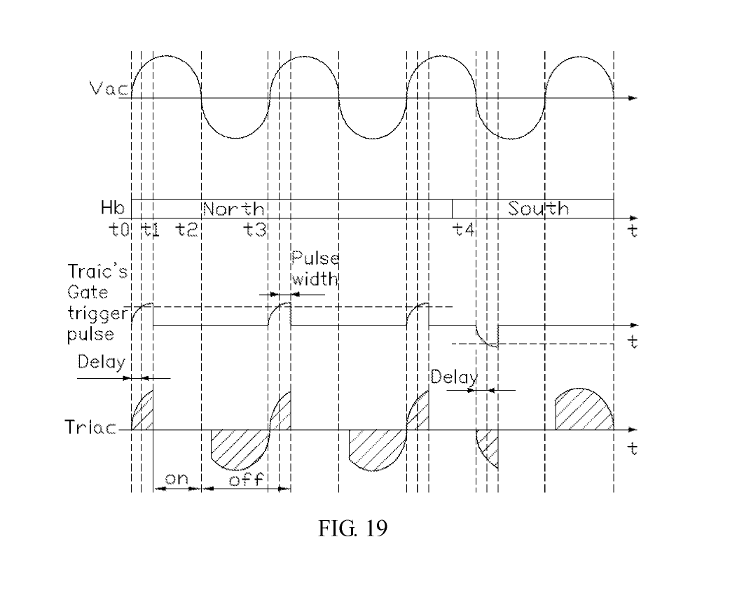

For example, at time instant t0, the position sensor 20 detects that the position of the magnetic pole of the rotor is at N pole, and a voltage polarity of the external alternating current power source is in a positive half cycle, the switch control circuit 30 sends a drive pulse for turning on the controllable bi-direction alternating current switch 26. Since a delay caused by the delay circuit 80 (a voltage between two terminals of the capacitor C1 rises as an accumulation of charges and cannot jump), the drive pulse is delayed for a certain time as Delay shown in FIG. 18, that is, the controllable bi-direction alternating current switch 26 is turned on at time instant t1. In specific operation, the drive pulse has a pulse width, and the controllable bi-direction alternating current switch 26 is turned on, after the switch control circuit 30 sends the drive pulse and the delay time Delay and the duration of the pulse width of the drive pulse are already passed. Preferably, if the duration of the pulse width of the drive pulse does not reach a preset duration, the extent is not enough to conduct the current, the controllable bi-direction alternating current switch 26 is not turned on. After the controllable bi-direction alternating current switch 26 is turned on, a current in the stator winding 16 of the motor increases gradually; the stator winding 16 inducts counter electromotive force and generates an expected torque to drive the rotor 14 to rotate in a preset direction such as a clockwise direction. At time instant t2, the position sensor 20 detects that the position of the magnetic pole of the rotor is at N pole, and a voltage polarity of the external alternating current power source is in a negative half cycle, the switch control circuit 30 does not send the drive pulse to the controllable bi-direction alternating current switch 26, the controllable bi-direction alternating current switch 26 is automatically turned off when the current flowing through the controllable bi-direction alternating current switch 26 is near a zero-crossing current. In practice, in a case that the motor has a very small inductance value such as a pure resistive load, the current outputted by the external alternating current power source 24 is near 0 ampere when the voltage of the external alternating current power source 24 is across zero, the current outputted by the external alternating current power source 24 is smaller than a holding current threshold of the controllable bi-direction alternating current switch, and the controllable bi-direction alternating current switch 26 is turned off. In other embodiments, if the motor has a high inductive load, the current being near 0 ampere occurs at a later time after the voltage of the external alternating current power source 24 is across zero. Referring to FIG. 19, the controllable bi-direction alternating current switch 26 is turned off at a later time after time instant t2. At the moment, the current flowing through the stator winding 16 is small (because reactive energy stored in the stator winding 16 is small), which does not generate a driving force to the rotor 14, therefore, the rotor 14 continues rotating in a clockwise direction at inertia effect. At time instant t3, the position sensor 20 detects again that the position of the magnetic pole of the rotor is at N pole, and the voltage polarity of the external alternating current power source is in a positive half cycle, a processing procedure of the motor driver circuit 19 at the time instant t3 is similar as the processing procedure of the motor driver circuit 19 at the time instant t0, which is not described herein.

At time instant t4, the position sensor 20 detects that the position of the magnetic pole of the rotor is at S pole, and the voltage polarity of the external alternating current power source is in a negative half cycle, the switch control circuit 30 controls the controllable bi-direction alternating current switch 26 to be turned on. The following processing procedure is similar as the processing procedure in a situation occurring in a same condition as above, which is not described herein.

A delay time of the delay circuit 80 may be determined by at least one of a voltage value of the external alternating current power source, a frequency of the external alternating current power source, an inductance value of the stator winding and an internal resistance of the stator winding. The more the voltage value of the external alternating current power source, the longer the delay time; the lower the frequency of the external alternating current power source, the longer the delay time; the smaller the inductance value of the stator winding, the longer the delay time; and the smaller the internal resistance of the stator winding, the longer the delay time. Specifically, according to the above description, the delay time of the delay circuit may be set by setting the capacitance value of the capacitor C1 and the resistance value of the resistor R1 in the delay circuit 80.

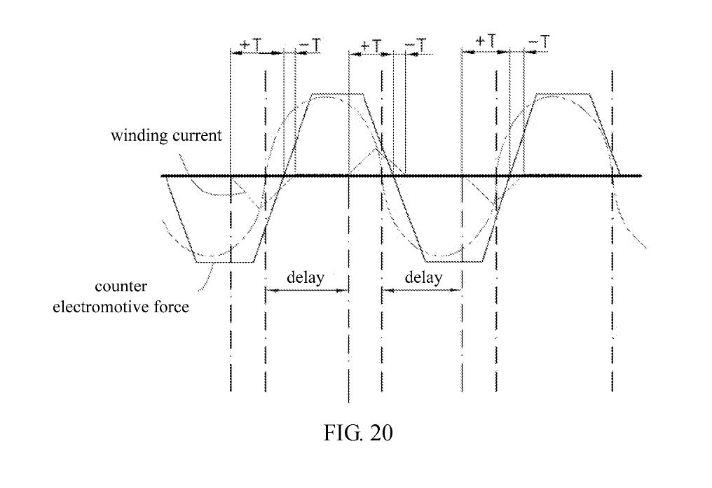

In the above-mentioned embodiments, in a case that the position of the magnetic pole of the rotor is at N pole and the voltage polarity of the external alternating current power source is in a positive half cycle, or in a case that the position of the magnetic pole of the rotor is at S pole and the voltage polarity of the external alternating current power source is in a negative half cycle, the switch control circuit 30 turns on the controllable bi-direction alternating current switch 26. In a case that the position of the magnetic pole of the rotor 14 is at N pole and the voltage polarity of the external alternating current power source is in a negative half cycle, or in a case that the position of the magnetic pole of the rotor 14 is at S pole, and the voltage polarity of the external alternating current power source is in a positive half cycle, the switch control circuit 30 does not turn on the controllable bi-direction alternating current switch 26. Since the delay effect of the delay circuit 80, when the controllable bi-direction alternating current switch 26 is turned on, a signal for turning on the controllable bi-direction alternating current switch 26 sent by the switch control circuit 30 is delayed for a delay time by the delay circuit 80 and is sent to the control terminal of the controllable bi-direction alternating current switch 26 after the delay time as shown in FIG. 20, which largely reduces cases that a phase of the counter electromotive force is different from a phase of the current of the stator winding and a negative torque (−T) is largely reduced.

The rectification circuit 28 in the embodiment adopts a full bridge rectification circuit. In other embodiments, the rectification circuit 28 may also adopt a half bridge rectification circuit, a full wave rectification circuit, or a half wave rectification circuit. In the embodiment, the voltage after being rectified is stabilized by a zener diode Z1. In other embodiments, electronic elements such as a three-terminal voltage regulator may also be used to stabilize a voltage.

It may be understood by those skilled in the art, the motor driver circuit 19 may be partly or entirely integrated inside an integrated circuit. For example, the motor driver circuit 19 may be embodied as an application specific integrated circuit (ASIC), to reduce a cost of the circuit and improve a reliability of the circuit. The integrated circuit includes a housing, some pins extending out from the housing, and a semiconductor substrate packaged in the housing, the part of the motor driver circuit packaged in the integrated circuit is disposed on the semiconductor substrate.

The integrated circuit may be designed based on an actual situation. For example, the position sensor 20, the switch control circuit 30 and the delay circuit 80 may be integrated inside the integrated circuit. For example, only the position sensor 20 and the switch control circuit 30 may be integrated inside the integrated circuit, and the rectification circuit 28, the delay circuit 80 and the controllable bi-direction alternating current switch 26 may be disposed out of the integrated circuit.

For example, the low power parts may be integrated inside the integrated circuit, and the resistor R0 and the controllable bi-direction alternating current switch 26 as the high power parts may be disposed out of the integrated circuit. For example, the capacitor C1 in the delay circuit and the controllable bi-direction alternating current switch 26 may be disposed out of the integrated circuit, and the others are integrated inside the integrated circuit.

It should be understood by those skilled in the art that the motor described in the embodiments of the disclosure may be used to drive devices, such as a fan, a pump, a household appliance or a vehicle (it is required a low voltage or high voltage alternating current power source in the vehicle, and an inverter is needed to drive a permanent magnet alternating current motor in a case that the vehicle does not include a low voltage or high voltage alternating current power source). The motor described in the embodiments of the disclosure is the permanent magnet alternating current motor, such as a permanent magnet synchronous motor, a permanent magnet BLDC motor. Preferably, the motor described in the embodiments of the disclosure is a single phase permanent magnet alternating current motor, such as a single phase permanent magnet synchronous motor, a single phase permanent magnet BLDC motor. In a case that the motor is the permanent magnet synchronous motor, the external alternating current power source is a commercial power supply. In a case that the motor is the permanent magnet BLDC motor, the external alternating current power source is an alternating current power source outputted by the inverter.

According to embodiments of the disclosure, in a case that a voltage polarity of the external alternating current power source corresponds to a position of the magnetic pole of the motor, the signal for turning on the controllable bi-direction alternating current switch sent by a switch control circuit is delayed for a delay time and is sent to the controllable bi-direction alternating current switch after the delay time. Based on such a control way, the motor is controlled to make a phase of a counter electromotive force be same with a phase of a current of a stator winding as more as possible, the expected torque is generated by the motor as more as possible, and a power consumption situation caused by a mutual resistance of positive torque and negative torque is reduced, thereby power utilization efficiency can be largely improved, which enhances resource conservation and environment protection.

The foregoing embodiments are only preferred embodiments of the disclosure and are not intended to limit the disclosure. All modifications, equivalent variations and improvements made without departing from the spirit and principle of the disclosure shall fall in the protection scope of the disclosure. For example, the driver circuit of the disclosure is applicable to not only a synchronous motor, but also other kinds of permanent magnet motor, such as a DC brushless motor.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A motor driver circuit comprising:
a controllable bi-direction alternating current switch connected in series with a motor across an external alternating current power source;
a switch control circuit configured to control the controllable bi-direction alternating current switch to be turned on or turned off in a preset manner; and
a delay circuit configured to delay a turn-on for the controllable bi-direction alternating current switch a preset time to decrease a phase difference between a current and a counter electromotive force flowing through the motor.

2. The motor driver circuit according to claim 1, wherein the delay circuit comprises a RC delay circuit, wherein a capacitor of the RC delay circuit is connected to a control terminal of the controllable bi-direction alternating current switch.

3. The motor driver circuit according to claim 1, further comprising a position sensor configured to detect a magnetic field of a rotor of the motor and then output a magnetic induction signal corresponding to the magnetic field; and wherein the switch control circuit is configured to control the controllable bi-direction alternating current switch to be turned on or turned off based on the magnetic induction signal and a polarity of a power signal outputted from the alternating current power source.

4. The motor driver circuit according to claim 3, wherein the switch control circuit is configured to:
turn on the controllable bi-direction alternating current switch, in a case that the polarity of the outputted power signal is positive and the detected magnetic induction signal is in a first polarity, or in a case that the polarity of the outputted power signal is negative and the detected magnetic induction signal is in a second polarity; and
turn off the controllable bi-direction alternating current switch, in a case that the power signal is negative and the detected magnetic induction signal is in the first polarity, or in a case that the power signal is positive and the detected magnetic induction signal is in the second polarity.

5. The motor driver circuit according to claim 3, further comprising a rectification circuit, wherein the rectification circuit comprises a high voltage output terminal and a low voltage output terminal; and in a case that the controllable bi-direction alternating current switch is turned on, the switch control circuit switches between a first state in which a current flows from the high voltage output terminal of the rectification circuit to a control terminal of the controllable bi-direction alternating current switch and a second state in which a current flows from the control terminal of the controllable bi-direction alternating current switch to the low voltage output terminal of the rectification circuit.

6. The motor driver circuit according to claim 5, wherein the switching of operation state of the switch control circuit between the first state and the second state is the case of immediately switching to one state after the other state ends, or the case of switching to one state after an interval time following the other state elapses.

7. The motor driver circuit according to claim 5, wherein the switch control circuit comprises a first switch and a second switch; wherein
the first switch is connected in a first current path, the first current path is disposed between the control terminal of the controllable bi-direction alternating current switch and the high voltage output terminal of the rectification circuit; and
the second switch is connected in a second current path, the second current path is disposed between the control terminal of the controllable bi-direction alternating current switch and the low voltage output terminal of the rectification circuit.

8. The motor driver circuit according to claim 7, wherein the delay circuit comprises a RC delay circuit, and the RC delay circuit comprises a capacitor connected to the control terminal of the controllable bi-direction alternating current switch and a resistor connected between the control terminal of the controllable bi-direction alternating current switch and a current output terminal of the first switch.

9. The motor driver circuit according to claim 7, wherein the switch control circuit further comprise a first resistor, NPN triode, a second resistor and a first diode connected in series between the control terminal of the controllable bi-direction alternating current switch and an output terminal of the position sensor, the cathode of the diode is connected to the output terminal of the position sensor, one terminal of the first resistor is connected to the high voltage output terminal of the rectification circuit, and the other terminal of the first resistor is connected to the output terminal of the position sensor; a base of the NPN triode is connected to the output terminal of the position sensor, an emitter of the NPN triode is connected to the anode of the diode; and collector of the NPN triode is connected to the high voltage output terminal of the rectification circuit; and the second resistor is formed as a RC delay circuit with a capacitor connected in series with the second resistor, and connected to the control terminal of the controllable bi-direction alternating current switch.

10. The motor driver circuit according to claim 3, wherein the switch control circuit comprises: a first current path in which a current flows to a control terminal of the controllable bi-direction alternating current switch; a second current path in which a current flows from the control terminal of the controllable bi-direction alternating current switch; and a switch connected in one of the first current path and the second current path, the switch is controlled by the magnetic induction signal to make the first current path and the second current path to be turned on selectively.

11. The motor driver circuit according to claim 10, wherein the other one of the first current path and the second current path does not comprise a switch.

12. The motor driver circuit according to claim 3, wherein the position sensor and the switch control circuit are integrated inside an integrated circuit; and the delay circuit comprises a RC delay circuit, a capacitor of the RC delay circuit is disposed out of the integrated circuit.

13. The motor driver circuit according to claim 3, wherein the position sensor, the switch control circuit and the delay circuit are integrated inside an integrated circuit.

14. The motor driver circuit according to claim 1, wherein the controllable bi-direction alternating current switch is connected between a first node and a second node, a stator winding of the motor and the alternating current power source are connected in series between the first node and the second node; or the stator winding of the motor and the controllable bi-direction alternating current switch are connected in series between the first node and the second node, and the first node and the second node are respectively connected to two terminals of the alternating current power source.

15. The motor driver circuit according to claim 1, wherein the delay circuit comprises an even number of NOT gates.

16. A motor component comprising a motor and the motor driver circuit according to claim 1.

17. The motor component according to claim 16, wherein the motor comprises a stator and a rotor, wherein the stator comprises a stator core and a single phase winding wound around the stator core.

18. The motor component according to claim 16, wherein the motor is a permanent magnet brushless motor.

19. An application device comprising the motor component according to claim 16.

20. The application device according to claim 19, wherein the application device comprises a pump, a fan, a household appliance, and a vehicle.
